(19) United States
(12) Patent Application Publication
(10) Pub. No.: US 2021/0110332 A1
(43) Pub. Date: Apr. 15, 2021

(54) COGNITIVE ACCOUNT STAFFING PLANNER

(71) Applicant: INTERNATIONAL BUSINESS MACHINES CORPORATION, Armonk, NY (US)

(72) Inventors: Ali KOC, WHITE PLAINS, NY (US); Ajay Ashok DESHPANDE, White Plains, NY (US); Sampoorna HEGDE, Bengaluru (IN); Brian Leo QUANZ, Yorktown Heights, NY (US); Narahari RAMACHANDRA, Bangalore (IN); Arun HAMPAPUR, Norwalk, CT (US); Deborah Marie BOLK, Fort Collins, CO (US); Steven LOEHR, Hopewell Junction, NY (US); Tinniam TINNIAM VENKATARAMAN GANESH, Bangalore (IN); Mohammed EHSANULLA, Chennai (IN)

(21) Appl. No.: 16/653,225

(22) Filed: Oct. 15, 2019

(51) Int. Cl. G06Q 10/06; H04L 12/24; G06K 9/62

(52) U.S. Cl. CPC G06Q 10/063118; H04L 41/5003; H04L 41/5019; G06K 9/6267; H04L 41/5074

(57) ABSTRACT

Staffing is allocated by expressing a risk of violating a service level agreement for a given service line as a function of a number of full-time equivalents allocated to the given service line and a number of service tickets received at the given service line per unit of time per ticket severity level. The number of service tickets are processed by the number of full-time equivalents allocated to the given service line. Risks are summed across a plurality of distinct service lines to generate a total risk. Total risk is minimized by adjusting the number of full time equivalents allocated to each given service line across all services lines subject to a pre-determined reduction in total cost to process all service tickets by the number of full-time equivalents across all service lines and a pre-determined range of a permissible number of full-time equivalents for each service line.

### FIELD OF THE INVENTION

The present invention relates to staffing optimization and risk minimization.

### BACKGROUND OF THE INVENTION

To increase profitability, businesses optimize processes and impose cost reduction requirements. Conventional methods for optimizing processes and achieving the desired cost reductions are based on multiple independent data sources, on gut feelings, and on general rules of thumb. However, the conventional methods do not consider the impact of staffing changes on Service Level Agreements (SLAs). The result is customer dissatisfaction and penalties associated with failure to meet the SLAs. Therefore, methods and system are needed that achieve the desired optimization of business processes and cost reductions while meeting SLAs and avoiding penalties.

### SUMMARY OF THE INVENTION

Exemplary embodiments are directed to systems and methods that improve the profitability in accounts or clients across serviced by staff located across different geographies. A cognitive account staffing planner (CASP) is a tool that enables account delivery project executives (DPEs) to make informed decisions regarding changes in staffing allocations. The CASP tool simulates a plurality of scenarios for different cost reductions and resource full time equivalent (FTE) optimizations. In one embodiment, the scenarios in the plurality of scenarios are subject to constraints including, for example, maximum and minimum resource optimization in specific services lines and skill levels associated with staff members. These constraints can be identified by the DPEs.

Having identified the plurality of scenarios, the CASP tool executes each scenario for the pre-determined cost take-out and any identified FTE reduction constraints. In one embodiment, FTE reduction constraints are specified for a given tower, service line or service competency. A given tower, service line or service competency is resource, e.g., computational resource, or service provided by the business or service provider to accounts, clients or customers. The CASP tool executes a given scenario to arrive at an optimal solution for cost take-out and FTE reduction that will result in the least risk, for a given account, of customer dissatisfaction and penalties. Account DPEs can use the CASP tool to simulate different scenarios and to compare the risk profiles across different scenarios. This comparison is used by the DPEs to make an informed decision for resource optimization.

Exemplary embodiments are directed to a method for allocating staffing. A risk of violating a service level agreement for a given service line is expressed as a function of a number of full time equivalents allocated to the given service line and a number of service tickets received at the given service line per unit of time per ticket severity level. The number of service tickets are processed by the number of full time equivalents allocated to the given service line. The risk of violating the service level agreement is summed across a plurality of distinct service lines to generate a total risk, and the total risk is minimized by adjusting the number of full time equivalents allocated to each given service line across all services lines subject to a pre-determined reduction in total cost to process all service tickets by the number of full time equivalents across all service lines and a pre-determined range of a permissible number of full time equivalents for each service line.

Exemplary embodiments are directed to a computer-readable medium containing a computer-readable code that when read by a computer causes the computer to perform method for allocating staffing. A risk of violating a service level agreement for a given service line is expressed as a function of a number of full time equivalents allocated to the given service line and a number of service tickets received at the given service line per unit of time per ticket severity level. The number of service tickets are processed by the number of full time equivalents allocated to the given service line. The risk of violating the service level agreement is summed across a plurality of distinct service lines to generate a total risk, and the total risk is minimized by adjusting the number of full time equivalents allocated to each given service line across all services lines subject to a pre-determined reduction in total cost to process all service tickets by the number of full time equivalents across all service lines and a pre-determined range of a permissible number of full time equivalents for each service line.

Exemplary embodiments are directed to a system for allocating staffing. The system includes a database containing historical data for the processing of service tickets in a plurality of service lines. The historical data include workload data containing all service tickets received per a given duration of time, clocking data comprising full time equivalent effort used to process all service tickets, service level agreements, and allocated numbers of full time equivalents per service line. The system also includes a risk modeler and optimizer module to use the historical data to express a risk of violating a service level agreement for a given service line as a function of a number of full time equivalents assigned to the given service line and a number of service tickets received at the given service line per unit of time per ticket severity level, to generate a total risk by summing the risk of violating the service level agreement across a plurality of distinct service lines, and to minimize the total risk by adjusting the number of full time equivalents allocated to each given service line across all services lines to create a plurality of risk minimization scenarios. The number of service tickets are processed by the number of full time equivalents allocated to the given service line, and each risk minimization scenario is a unique arrangement of changes in the risk of violating the service level agreement for each ticket severity level per service line, changes in the number of full time equivalents in each full time equivalent classification band per service line, and total cost. The system also includes a user interface and scenario output module in communication with the risk modeler and optimizer module to display the plurality of risk minimization scenarios.

### BRIEF DESCRIPTION OF THE DRAWINGS

FIG. 1 is a schematic representation of an embodiment of a cognitive account staffing planner;

FIG. 2 is a schematic representation of an embodiment of the functionality of a data transformer module;

FIG. 3 is a flow chart illustrating an embodiment of a method for allocating staffing;

FIG. 4 depicts a cloud computing environment according to an embodiment of the present invention; and

FIG. 5 depicts abstraction model layers according to an embodiment of the present invention.

### DETAILED DESCRIPTION

Exemplary embodiments are directed to a cognitive account staffing planner (CASP) and methods for using the cognitive account staffing planner to maximize account profitability and to rebalance human resources, i.e., full time equivalents (FTEs) while minimizing risk. As used herein, an account is a given client or customer to which a business or enterprise is providing a service or a suite of services. Risk is the risk of service level agreement (SLA) violations or penalties for a given account or across all accounts. The SLAs are identified, for example, from the contract or services agreement between the business and the account. A user of the CASP inputs business constraints and goals into the CASP. Suitable business constraints include, but are not limited to, maximum staffing change allowed for a given service line, permissible FTE change levels by job skill, permissible FTE change levels by job role, permissible FTE change levels by geography or location, change target cost reduction, SLA status by service line, SLA risks by service line, profitability by service line and customer satisfaction by service line.

As used herein, a tower, service line or service competency is a given service or functionality provided to accounts. For example, a tower is a grouping of computational resources that are utilized by a given software product of the service provider. Employees are skilled in a given tower, service line or service competency. Exemplary service lines include, but are not limited to, server management, storage management, application hosting and system operations. A given account, client or customer is provided with one or more service lines, and the service lines can include multiple specific types of a given service line. For example, the business can provide a given account with the following specific service lines: server management—distributed Intel, server management—distributed Unix, storage management—distributed, application hosting—domino server, application hosting—domino mailbox, system operations—distributed image, system operations—sec HChk Intel, system operations—sec HChk Unix and server management—mainframe image.

The CASP utilizes the service lines for each given account and the current staffing levels for the service lines and given accounts in developing the desired optimization models. The staffing levels are expressed as FTEs per service line and per account. For example, a single employee devoted exclusively to providing a given service line to the account represents 1 FTE. However, four employees each devoting 25% of their time in the given service line to the account also represents 1 FTE. These four employees are devoting other portions of their time to other service lines or other accounts. By optimizing staffing in terms of FTE, human resources, e.g., human resources for the business and for the service lines, are allocated or optimized across multiple accounts. For example, the CASP is provided with the following current staffing levels: server management—distributed intel (90 FTE), server management—distributed Unix (160 FTE), storage management—distributed (79 FTE), application hosting—domino server (40 FTE), application hosting—domino mailbox (15 FTE), system operations—distributed image (40 FTE), system operations—sec HChk Intel (17 FTE), system operations sec HChk Unix (15 FTE) and server management—mainframe image (30 FTE).

Suitable goals that are input into and used by the CASP include, but are not limited to, reduce cost from a given account, free up selected types and amounts of service line skills to support new projects and identify opportunities for optimized staffing for maximizing profit. The CASP utilizes all constraints, goals and current staffing levels to maximize account profitability by rebalancing investment or staffing levels across service lines while minimizing the risk of SLA violations. In one embodiment, the CASP produces a plurality of optimization models or optimization scenarios. Each optimization model includes a projected cost to the business, staffing allocation, e.g., FTE per service line across all service competencies for the account, and an identification of the risk of an SLA violation or penalty. In one embodiment, the CASP displays the plurality of optimization models in a multi-scenario comparator.

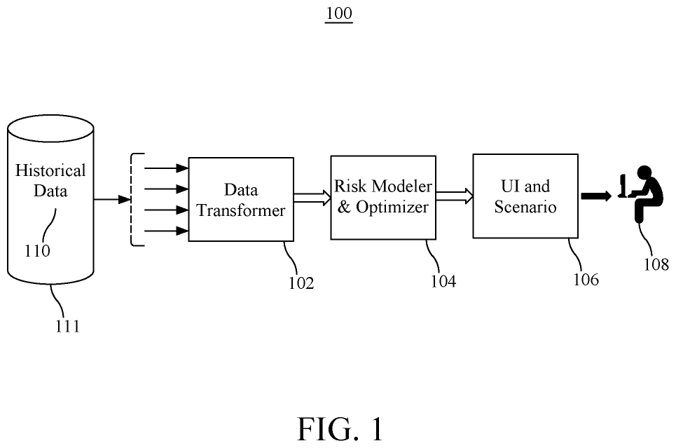

Referring initially to FIG. 1, an exemplary embodiment of a CASP 100 is illustrated. Exemplary embodiments are directed to value driven cost optimization using the CASP. The CASP includes at least one database 111 containing historical data 110 for the processing of service tickets in a plurality of service lines. In one embodiment, the historical data are arranged in a plurality of datasets including a workload dataset, an SLA dataset, a resources dataset, a constraint dataset, a clocking data dataset, and a ledger dataset. In one embodiment, the historical data include workload data containing all service tickets received per a given duration of time, clocking data containing full time equivalent effort used to process all service tickets, service level agreements, and allocated numbers of full time equivalents per service line.

In one embodiment, the workload dataset or workload data include, for example, incident tickets, charge tickets, service requests, work orders and problem tickets. A given service line produces tickets for that service line. The FTEs within the given service line are responsible for responding to the tickets produced by the given service line. Each ticket has an associated risk level, i.e., risk of causing a failure to meet an SLA or risk of incurring a penalty. In one embodiment, the workload dataset includes ticket data containing information as indicated in Table 1. The ticket data include the severity level associated with each ticket. In one embodiment, severity levels are used by the CASP to generate risk data. Alternately, the CASP uses SLAs and contractual obligations to identify the SLA violation thresholds.

TABLE 1
Workload Ticket Data

| Data Attributes | Mandatory | Description |
|---|---|---|
| Incident Number | Yes | Unique identification number for |
| | | each incident |
| Ticket Resolved Date | Yes | Date of ticket resolution |
| Ticket Status | Yes | Current status of ticket |
| Ticket Priority/ | Yes | Severity level, e.g., Severity 1, |
| Severity | | Severity 2, Severity 3, Severity 4, |
| | | and priority, e.g., critical, high, |
| | | medium, low, assigned to the ticket. |
| Assignment Group/ | Yes | Identifies the primary group |
| Queue ID | | responsible for resolving the ticket. |
| | | The primary group can be unique to |
| | | each account. This data field is |
| | | mapped to the tower and service line. |
| Ticket Categorization | No | Ticket categories indicate specific |
| | | account related keywords to identify |
| | | SLA linked |
| | | applications/servers/system issues. |
| | | Categorization is optional but |
| | | improves risk calculation. |

The SLA dataset or SLA data include SLAs for accounts as expressed, for example, in a contract or service agreement between the business and the account. The constraint database or constraint data identifies the constraints imposed on the CASP when reducing costs and optimizing the utilization and distribution of FTEs. Constraints within the constraint database include, for example, constraints on the classification of workloads, risks and resources, target increases in profit, service lines having FTEs that cannot be modified, minimum FTEs in a given service line and maximum FTEs in a given service line. The constraints can be defined, for example, by contract, by the user of the CASP or by the business. The clocking database or clocking data (ILC data) contain data on employee, i.e., full time equivalent, effort spent managing the workload and the cost associated with that effort. The cost is associated with a given employee or FTE and varies depending on the FTE classification band, i.e., cost band and experience band, associated with the FTE. More experienced or higher level FTEs are grouped into an associated higher cost band. In one embodiment, the clocking data include the information as indicated in Table 2.

TABLE 2
Clocking Data

| Data Attributes | Comments |
|---|---|
| Week Ending Date | Date of clocking |
| Standard Unit Price | Cost for FTE based on band |
| Work Item ID | Work item ID, Account ID mapped to service line |
| Account ID | Work item ID, Account ID mapped to service line |
| Ledger Month | The month in which clocking |

The resource dataset or resource data include information on existing or available FTEs including an identification of the tower containing the FTE, the geography of the FTE, i.e., off-shore or on-shore, and the FTE classification band of the resource. Each classification band has an associated hourly pay for FTE or hourly cost based on the experience of the personnel, and the CASP can utilize a plurality of classification bands. In one embodiment, the classification bands are compressed into three groups, i.e., high, medium or low. The ledger dataset or ledger data include ledger details for the profitability achieved from each tower.

The plurality of datasets from the accounts stored in the database are used by the CASP tool to obtain the optimal staffing allocation. The CASP also includes a plurality of modules that utilize the information stored in the database to create the optimization scenarios. Each module represents a combination of hardware and software resources used to provide the desired functionality. These hardware and software resources can be cloud-based or distributed hardware and software resources. The historical data 110 pass through the plurality of modules to deliver the desired optimization modules or optimization scenarios to the user 108, for example, the account delivery project executive (DPE), for use in a given account, e.g., a given client. As illustrated, the CASP includes three stages that are processed by three modules. However, the CASP can include more than three or less than three modules or stages. The three modules are the data transformer module 102 in communication with the database, the risk modeler and optimizer module 104 in communication with the data transformer module, and the user interface (UI) and scenario comparison module 106 in communication with the risk modeler and optimizer module.

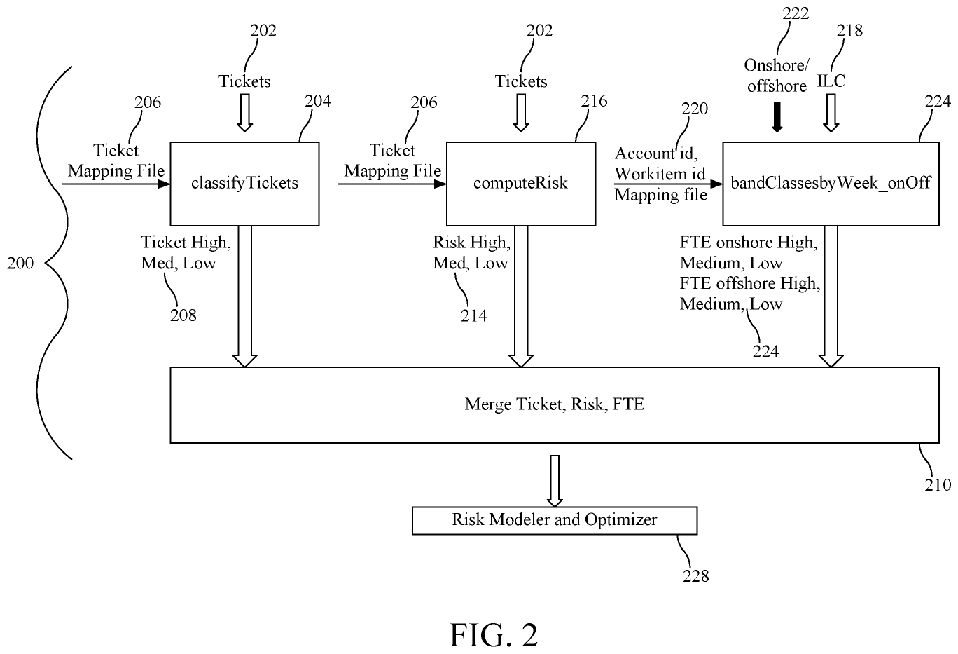

In one embodiment, the historical data for the provision of service lines to accounts are initially processed by the data transformer module 102. Referring to FIG. 2, in one embodiment, the data transformer module 200 receives the workload data 202 containing service ticket data and clocking data 218. The data transformer module also receives service ticket mapping files 206 that map each service ticket to a given service line and clocking data mapping files 220 to map full time equivalent effort to a given service line. In one embodiment, the service ticket mapping files and clocking data mapping files are stored in the database. The service ticket data and service ticket mapping files are used by the data transformer module to classify each service ticket 206 in each service line. The service tickets are classified as high severity service tickets, medium severity service tickets and low severity service tickets 208. Similarly, the data transformer module uses the service ticket data and service ticket mapping files to classify the service tickets by risk 216. The service tickets are classified into a low risk class, a medium risk class and a high risk class 214.

Similarly, the transformer module uses the clocking data 218, the clocking data mapping files 220 and full time equivalent geolocation data 222, e.g., onshore or offshore, to classify each full time equivalent in the allocated number of full time equivalents in each service line 224 into one of six FTE classification bans. These FTE classification bands include an offshore low classification band, an offshore medium classification band, an offshore high classification band, an onshore low classification band, an onshore medium classification band or an onshore high classification band 226. Each FTE classification band has a given level of technical competency associated with a given full time equivalent and a cost per unit time associated with each full time equivalent in the classification band. The transformer module then merges all transformed and classified historical data by service line 210 and communicates the merged transformed data to the risk modeler and optimizer module 228.

Processing the historical data transforms the historical data into groups of ticket data by service line and groups of clocking data or FTE by service line. In one embodiment, the data transformation module transforms the historical data from all datasets to facilitate merging the historical data by the account service lines. Transformation of the historical data includes classifying the tickets, risk and FTE levels. In one embodiment, classification of tickets, risk and FTE utilizes the mapping files. The two groupings are then merged together using mapping files, for example, as provided by the accounts or users, i.e., DPEs, to create transformed historical data for each service line by week. These mapping files map all the datasets to a common account service line of a given account. Mapping to a common account service line enables the datasets to be merged together and mapped in the respective buckets or classes, e.g., by severity level or risk level and cost. The CASP also considers contracted FTEs. Contracted FTEs, which are prescribed in the contract, are not touched or modified.

An example of the classification rules for ticket data, and for risk data having severity levels based on ticket data, is illustrated in the Table 3.

TABLE 3
Merging and Classifying Ticket Data

| Ticket Classification | Remarks |
|---|---|
| Select ticket data between dates | |
| Map Assignment Group/Queue Id to Service | |
| Line | |
| Tickets | |
| SEV 1 & SEV 2 | High |
| SEV 3 | Medium |
| SEV 4 | Low |
| Compute High, Medium, Low ticket counts by | |
| week | |

An example of the classification rules for clocking data is illustrated in Table 4.

TABLE 4
Merging and Classifying Clocking Data

| FTE Classification | Remarks |
|---|---|
| Select Clocking data based on ledger month | |
| Filter based on geography | |
| Onshore | US |
| Offshore | Non-US |
| Classify based on Band Rate | |
| Standard Unit Price <13 | Low Band |
| 13 < Standard Unit Price < 20 | Medium Band |
| Standard Unit Price >20 | High Band |
| Aggregate FTE bands by week | |

The resulting merged data contain tickets classified into three severity level categories. In one embodiment, these three severity level categories are high severity, medium severity and low severity. The severity of the tickets is used to create three risk classes, high risk, medium risk and low risk. Risk expresses the expected number of violated tickets based on the SLA, contract or service agreement. In addition, FTE allocation is classified for a given service line into 3 buckets or bands, high allocation, medium allocation and low allocation for both onshore and offshore. This results in six total FTE allocations for each service line.

Returning to FIG. 1, the merged transformed historical data are used by a risk modeler in the risk modeler and optimizer module 104 to prepare the necessary input to execute the CASP optimizer in the risk modeler and optimizer module. In one embodiment, the risk modeler and optimizer module uses the historical data to express a risk of violating a service level agreement for a given service line as a function of a number of full time equivalents assigned to the given service line and a number of service tickets received at the given service line per unit of time per ticket severity level. The number of service tickets are processed by the number of full time equivalents allocated to the given service line. The risk modeler and optimizer module also uses the historical data to generate a total risk by summing the risk of violating the service level agreement across a plurality of distinct service lines. Given the total risk, the risk modeler and optimizer modeler minimizes the total risk by adjusting the number of full time equivalents allocated to each given service line across all services lines to create at least one and preferably a plurality of risk minimization scenarios. Each risk minimization scenario is a unique arrangement of changes in the risk of violating the service level agreement for each ticket severity level per service line, changes in the number of full time equivalents in each full time equivalent classification band per service line, and a total cost.

Therefore, the risk modeler and optimizer module generates allocation scenarios that minimize the total number of expected violations. In one embodiment, the risk modeler and optimizer module takes snapshots of the transformed historical data for a given account at weekly intervals for a given duration. In one embodiment, the given duration is greater than a year. The risk modeler and optimizer module estimates the probability of total or overall risk, i.e., the expected number of violated tickets. In one embodiment, total risk is a summation of all risks. In one embodiment, total risk is a weighted combination of risks based on severity level. The total risk is estimated using the FTE in the three different allocation classes for both onshore and offshore and the ticket velocity, i.e., the volume or number of tickets per time period, e.g., per week, per service line per ticket severity class. Similarly, risk or violations is expressed as the violated number of tickets per time period, i.e., per week, per service line per risk severity class.

In one embodiment, the risk modeler and optimizer module uses two approaches to estimate the probability of overall risk. In a first approach, the risk modeler and optimizer module directly predicts the number of violations given FTE and ticket velocity. The first approach uses a count model based on poisson regression. In the second approach, the risk modeler and optimizer module first predicts the probability of a ticket getting violated given FTE and ticket velocity. The risk modeler and optimizer module then multiplies this predicted probability by volume numbers to obtain an expected number of violations. To predict the probability of a ticket getting violated, risk modeler and optimizer module builds and validates various machine learning models. Suitable machine learning models include, but are not limited to, logistic regression, k-nearest neighbor, random forest, support vector machines, and Gaussian Naïve Bayes. Preferably, the risk modeler and optimizer module uses logistic regression, which achieves the best accuracy and cross entropy.

This estimated probability of overall risk is used by the risk modeler and optimizer module as the objective function for minimization. The objective function is minimized subject to specified or pre-determined constraints. In one embodiment, the constraints are the desired cost take out and the percentage FTE reduction in the specified service lines. For the first approach that uses the count model, the risk modeler and optimizer module uses solvers in the open source nlopt optimization library. Preferably, the risk modeler and optimizer module uses a convex optimization algorithm as the objective function is convex. For the second approach that uses logistic regression, the risk modeler and optimizer module uses a derivative free solver from the nlopt library. The second approach lends itself to a sigmoid programming algorithm, as the objective function has a sigmoidal form. The risk modeler and optimizer module determines the FTE distribution for the different service lines that results in the least overall risk for the given desired cost take out, i.e., cost reduction, and FTE reduction. In one embodiment, the risk modeler and optimizer module determines the FTE distribution for the different service lines that results in the least overall risk for a plurality of different combinations of cost take out and FTE reduction. Each cost take out and FTE reduction combination is referred to as a given scenario.

The risk modeler and optimizer module communicates the optimized scenarios to the user interface (UI) and scenario comparison module 106, which in one embodiment is based on Peretz framework and the JavaScript framework AngularJS. The UI and scenario module displays the results of the risk modeler and optimizer module to the user 108, e.g., the DPE. As the risk modeler and optimizer module can be executed for the plurality of different cost take out and FTE reduction combinations, the UI and scenario comparison module allows the DPE to create and to compare the plurality of different scenarios for multiple combinations of cost takeout and FTE reduction. In addition, the DPEs can compare the different scenarios, for example, in either table format or graphical format, and can choose the most appropriate scenario for actual implementation. Having selected the desired scenario, human resources, i.e., FTEs, are allocated across service lines in accordance with the scenario.

Table 5 illustrates the results of changes in overall risk and the associated changes in FTE levels are illustrated across thirteen service lines for a given account. This table is displayed to the user by the UI and scenario module. Multiple runs with different changes in risk and FTE level are used to produce multiple versions of Table 5, all of which are provided to the user. As illustrated for the Wintel service line, all FTE allocation buckets are decreased to the minimum bound except for the off-shore low-skill bucket, which was reduced to a level close to the lower bound. The off-shore low-skill bucket had one of the cheaper costs per FTE (1,251.5). Therefore, other FTE allocation buckets can be used to achieve more cost reduction with similar risk impact. For example, the unix risk model is insensitive to FTE change as well and has room left to decrease the off-shore medium bucket—which has a greater cost per FTE of 1,636.6. In addition, the off-shore low-skill allocation bucket may not have reduced all the way because of difficulty finding the exact constrained solution with the optimization method used.

TABLE 5
Example of Violation Risk Change and Total FTE Change

| | | Original | Solution | Change in | |
|---|---|---|---|---|---|
| | | Violation | Violation | Violation | |
| | | Risk | Risk | Risk | |
| | Service | TktRisk- | TktRisk- | TktRisk- | Change in |
| | Line | High | High | High | Total FTE |
| 0 | Batch | 10.9 | 11.1 | 0.3 | −0.7 |
| | Operations | | | | |
| 1 | Build | 0.0 | 0.0 | 0.0 | −3.9 |
| 2 | Capacity | 3.1 | 3.1 | 0.0 | −1.5 |
| 3 | Citrix | 38.3 | 0.5 | −37.8 | 7.4 |
| 4 | KP Cloud | 0.0 | 0.1 | 0.1 | −4.2 |
| 5 | LCM | 12.8 | 12.8 | 0.0 | −39.8 |
| 6 | Mainframe | 54.6 | 0.5 | −54.1 | 23.0 |
| 7 | Middleware | 22.2 | 22.2 | 0.0 | −12.9 |
| 8 | Notes | 76.2 | 0.7 | −75.5 | 6.9 |
| 9 | STORAGE | 67.5 | 13.2 | −54.3 | 14.7 |
| 10 | Sharepoint | 11.7 | 0.0 | −11.7 | 2.1 |
| 11 | TWS | 17.9 | 3.0 | −14.9 | −3.2 |
| 12 | Unix | 77.2 | 77.2 | 0.0 | −31.5 |
| 13 | Wintel | 100.0 | 100.0 | 0.0 | −29.9 |

The CASP optimization algorithm minimizes the overall risk for the service lines of an account subject to constraints of overall cost reduction distributed across the account service lines. Overall risk minimization is accomplished by modeling a probability function of the factors that contribute to the overall risk. Key factors contributing to the overall risk in a given account include FTE and ticket velocity. Overall risk minimization is subject to the total cost take out from the account for a specified upper and lower bound of FTE reduction in the tower.

In one embodiment, CASP optimization or CASP staffing optimization is represented as:

Minimize ΣRisk(FTE,TicketVelocity) (1)

Subject to the constraints:

Σcost take out across towers<total cost (2)

upper bound>FTE reduction>lower bound (3)

The risk function illustrated in equation (1) is an exponential function when the count model is used and a sigmoidal function multiplied by ticket volumes when the logistic model is used. The exponential function is in the form of f(x)=e^{x}, and the exponential risk function indicates the number of SLA violations for a given ticket as a function of FTE and TicketVelocity. Historical data for the account containing SLA violations on specific weeks and for specific service lines in the high, low and medium buckets are used to build a risk violation model. The sigmoidal function is in the form f(x)=1/(1+e^{-x}) and indicates the probability of an SLA violation for a given ticket as a function of FTE and ticket velocity, i.e., p(FTE, TicketVelocity). Again, historical data for the account containing SLA violations on specific weeks and for specific service lines in the high, low and medium buckets are used to build a risk violation model.

Since the CASP optimization algorithm minimizes overall risk, the minimization problem reduces to an optimization problem. For the count model, the log likelihood of error is minimized. In one embodiment, the log likelihood of error is Σ(YᵢθXᵢ−eθ^{Xi}), where Y represents the risk observations and X represents the features. The variable θ expresses the coefficients of the final model so that Risk(FTE, TicketVelocity)=e^{-(W1FTE+W2TicketVelocity)}. For the logistic model, the log likelihood error of the sigmoidal function is minimized. In one embodiment the log likelihood error of the sigmoidal function is:

L=−[Y log A+(1−Y)log(1−A)] (4)

where Y is the actual SLA risk violation data for different towers in different weeks for high, medium and low and A is the computed probability function, based on the weighted set of variables, i.e., p(FTE, TicketVelocity)=1/(1+e^{-(W1FTE+W2TicketVelocity)}. To minimize the loss as given by equation (4), convex optimization using the constraints (2) and (3) is applied.

Equation (1) in the expanded form is:

$${min}_{x} {\sum }_{i = 1 … n , j ∈ \{ L , M , H \}} {Risk}_{i , j} ( {x}_{i , Lon} , {x}_{i , Mon} , {x}_{i , Hon} , {x}_{i , Loff} , {x}_{i , Moff} , {x}_{i , Hoff} {v}_{i , L} , {v}_{i , M} , {v}_{i , H} )$$

Subject to the constraints:

$${\sum }_{i = 1 … n , j ∈ \{ L , M , H \}} {r}_{i , j} {x}_{i , j} < T$$

$${m}_{i , j} < {x}_{i , j} < {M}_{i , j} ∀ i , j$$

### Where

x_{i,Lon}, x_{i,Mon}, x_{i,Hon}—Onshore FTE assigned to competency i and skill level j
x_{i,Loff}, x_{i,Moff}, x_{i,Hoff}—Off shore FTE assigned to competency i and skill level j
r_{i,j} is the cost per FTE for competency i, and skill level j
m_{i,j} and M_{i,j} are upper and lower bounds, respectively, on FTE for competency i and skill level j
   Where x_{i,L}, x_{i,M}, x_{i,H}—are the FTE's in the Low, Medium and High towers for different skills in onshore and offshore.

When the count model is used, risk is given by the exponential function:
e^{(w}^{₁}^{x}^{_{i,L}}^{+w}^{₂}^{x}^{_{i,M}}^{+w}^{₃}^{x}^{_{i,H}}^{+w}^{₄}^{v}^{_{i,L}}^{+w}^{₅}^{v}^{_{i,M}}^{+w}^{₆}^{v}^{_{i,H}}^{+b)}
   When the logistic model is used, risk is given by the sigmoid function with the real factors multiplied by volume numbers. The sigmoid function is given by:

$${p}_{i , j} ( {x}_{i , L} , {x}_{i , M} , {x}_{i , H} , {v}_{i , L} , {v}_{i , M} , {v}_{i , H} ) = \frac{1}{1 + {e}^{- ( {w}_{1} {x}_{i , L} + {w}_{2} {x}_{i , M} + {w}_{3} {x}_{i , H} + {w}_{4} {v}_{i , L} + {w}_{5} {v}_{i , M} + {w}_{6} {v}_{i , H} + b )}}$$

Table 6 illustrates an optimization run for a given account over four weeks with a $200,000 cost reduction target and the constraints of a maximum 30% change in FTE per allocation bucket, i.e., skill level and geography. The table shows the FTE levels in each one of the six allocation buckets across five service lines given the associated ticket velocities.

TABLE 6
Example Optimization Run

| | FTE- | FTE | FTE | FTE | FTE | FTE | | | |
|---|---|---|---|---|---|---|---|---|---|
| | High | Medium | Low | High | Medium | Low | Tkt | Tkt | Tkt |
| Service | Onshore | Onshore | Onshore | Offshore | Offshore | Offshore | High | Medium | Low |
| Line | sum | sum | sum | sum | sum | sum | sum | sum | sum |
| Batch Ops | 0.0 | 0.0 | 0.0 | 1.3 | 4.3 | 26.3 | 5.0 | 2157 | 862 |
| Build | 0.0 | 0.0 | 0.0 | 4.4 | 4.4 | 4.1 | 0.0 | 5 | 1 |
| Capac. | 0.0 | 0.0 | 0.0 | 1.9 | 1.1 | 2.0 | 0.0 | 5 | 20 |
| Citrix | 1.2 | 2.7 | 0.0 | 13.1 | 8.8 | 6.6 | 49 | 3967 | 813 |
| KP Cloud | 2.8 | 0.6 | 0.0 | 5.7 | 11.2 | 16.6 | 0.0 | 3 | 0.0 |

In one embodiment, the CASP model is refined using one or more refinements. Suitable refinements include, but are not limited to, regularization, common sense rules, skill substitution, imputation of values and sparsity management. In one embodiment, L2 Regularization is used to set the weights of features that do not contribute to the Risk to 0. In one embodiment, common sense rules are applied by adjusting the weights of the different features based on common sense inferences. A first inference is that adding FTEs to service lines will reduce overall risk or will maintain overall risk at a given level, i.e., overall risk will not get worse. Therefore, the weights of features associated with FTEs are in the range (negative infinity,0). A second inference is that increasing ticket volume increases overall risk or maintains overall risk at the same level. Therefore, the weights of ticket volume are in the range (0, infinity).

The skill substitution refinement regularizes the weights of the low, medium and high FTE bands based on the relative skill level. To regularize the weights, W_{i,L}=W_{i,L}+W_{i,M}+W_{i,H}, i.e., the weight for the FTE in tower ‘I’ for the Low band is the sum of the weights in the Low, Medium and High. In addition, W_{i,LM}=W_{i,M}+W_{i,H} and W_{i,LH}=W_{i,H}. Therefore, after optimization the W_{i,H}>=W_{i,M}>=W_{i,L}. Imputation of values is used to fill in missing data for the service lines and allocation bands. To manage data sparsity, L2 regularization is employed, the machine learning models of CASP use additional constraints. Other techniques for handling data sparsity create shared machine learning models where all the models are trained simultaneously and use some common constraint, e.g., the average of the weights. In one embodiment, bootstrap methods are used when there is sparsity of data.

Following creation of the CASP model, the CASP model is validated. In one embodiment, leave-one-out cross validation is performed for the count model, the simple linear regression, the baseline, i.e., taking just sample mean of violations, and the logistic model. Table 7 illustrates the results for high level tickets for a given account.

TABLE 7
Cross Validation of CASP Model

| | Count | Linear | Mean | Logit |
|---|---|---|---|---|
| MAE | 4.528e+10 | 7.632 | 11.742 | 6.399 |
| MAE/MEAN | 4.736e+09 | 0.798 | 1.228 | 0.653 |
| MAPE+1 | 7.817e+07 | 1.538 | 3.101 | 0.786 |
| MSE | 5.745e+23 | 1041.264 | 1649.000 | 1428.359 |
| R2 | −3.475e+20 | 0.370 | 0.003 | 0.156 |
| SMAPE+1 | 6.616e−01 | 0.749 | 0.833 | 0.476 |

Where MAE is the mean absolute error, and MAE/MEAN is the MAE divided by the sample mean of risks. MAPE+1 is the mean absolute percentage error with one added to the denominator to avoid zero divisions or very high numbers. R2 is the deviation explainable by the model, and SMAPE+1 is the symmetric version of MAPE+1.

Model validation takes one week of overall risk, i.e., total violations, and predicts the overall risk for that one week using each one of the other weeks. An average is then taken using the risk for all other weeks. As illustrated in the Table 6, the count model gives very high inaccuracies. This high inaccuracy for the count model holds for other ticket categories, i.e., medium and low, and for other accounts.

To evaluate the performance of the count model and logistic model for each individual tower, the count model and logistic model are validated for each individual service. The results of this validation are given in Table 8.

TABLE 8
Validation Across Service Lines

| | Count | | Logit | |
|---|---|---|---|---|
| | MAE/MEAN | MAPE+1 | MAE/MEAN | MAPE+1 |
| Service Line 1 | 1.923e+10 | 6.421e+08 | 1.013 | 1.224 |
| Service Line 2 | 1.214e+03 | 1.549e+02 | 0.557 | 0.401 |
| Service Line 3 | 2.763e+02 | 2.047e+02 | 0.598 | 0.408 |
| Service Line 4 | 7.548e−01 | 7.617e−01 | 0.956 | 0.889 |
| Service Line 5 | 9.043e−01 | 6.316e−01 | 0.894 | 1.012 |
| Service Line 6 | 6.304e−01 | 7.961e−01 | 0.557 | 0.834 |
| Service Line 7 | 1.330e+04 | 1.739e+04 | 0.121 | 0.953 |
| Service Line 8 | 1.612e+08 | 1.000e+07 | 0.107 | 0.540 |
| Service Line 9 | 3.331e+03 | 9.252e+02 | 1.388 | 0.297 |
| Service Line 10 | 1.171e+02 | 4.441e+01 | 1.166 | 0.687 |
| Service Line 11 | 1.354e+02 | 6.691e+01 | 0.744 | 0.456 |
| Service Line 12 | 1.471e+01 | 4.736e+00 | 2.000 | 0.500 |
| Service Line 13 | 1.162e+00 | 1.089e+00 | 1.069 | 1.144 |
| Service Line 14 | 0.000e+00 | 1.315e−09 | 0.000 | 0.000 |

As illustrated in Table 8, the count model performs poorly on quite a few service lines with respect to MAE/MEAN and MAPE+1. The logistic model performs well across all service. These results are valid for other ticket categories and for other accounts.

Validation indicates that using the logistic model, i.e., predicting probabilities of individual ticket violations and calculating the overall risk accordingly, produces better performance than using mean, linear regression or the count model to predict risk directly. The logistic model is then evaluated for accuracy in predicting probabilities of individual ticket violations with respect to two logistic models. Results of this evaluation are given in Table 9.

TABLE 9
Logistic Model Accuracy Evaluation

| | Accu- | Accu- | | | | Neg. | | |
|---|---|---|---|---|---|---|---|---|
| | racy | racy2 | LogLoss | NPR | N_hit | perc. | PPR | P_ hit |
| Service | 0.625 | 0.625 | 1.786 | 0.682 | 0.237 | 0.429 | 0.616 | 0.917 |
| Line 1 | | | | | | | | |
| Service | 0.393 | 0.393 | 6.479 | NaN | 0.000 | 0.607 | 0.393 | 1.000 |
| Line 2 | | | | | | | | |
| Service | 0.365 | 0.365 | 0.736 | 0.434 | 0.697 | 0.524 | 0.000 | 0.000 |
| Line 3 | | | | | | | | |
| Service | 0.530 | 0.530 | 0.845 | 0.544 | 0.935 | 0.554 | 0.250 | 0.027 |
| Line 4 | | | | | | | | |
| Service | 0.636 | 0.636 | 1.920 | NaN | 0.000 | 0.364 | 0.636 | 1.000 |
| Line 5 | | | | | | | | |
| Service | 0.728 | 0.728 | 0.677 | NaN | 0.000 | 0.272 | 0.728 | 1.000 |
| Line 6 | | | | | | | | |
| Service | 0.645 | 0.645 | 0.680 | 0.387 | 0.077 | 0.340 | 0.664 | 0.938 |
| Line 7 | | | | | | | | |
| Service | 0.947 | 0.947 | 0.180 | 0.947 | 1.000 | 0.947 | NaN | 0.000 |
| Line 8 | | | | | | | | |
| Service | 0.855 | 0.855 | 0.283 | 0.855 | 1.000 | 0.855 | NaN | 0.000 |
| Line 9 | | | | | | | | |
| Service | 0.821 | 0.821 | 0.511 | NaN | 0.000 | 0.179 | 0.821 | 1.000 |
| Line 10 | | | | | | | | |
| Service | 0.600 | 0.600 | 14.231 | 0.600 | 1.000 | 0.600 | NaN | 0.000 |
| Line 11 | | | | | | | | |
| Service | 0.800 | 0.800 | 7.452 | 0.800 | 1.000 | 0.800 | NaN | 0.000 |
| Line 12 | | | | | | | | |
| Service | 0.333 | 0.333 | 11.975 | 0.000 | 0.000 | 0.333 | 0.500 | 0.500 |
| Line 13 | | | | | | | | |
| Service | 0.823 | 0.823 | .0477 | NaN | 0.000 | 0.177 | 0.823 | 1.000 |
| Line 14 | | | | | | | | |

Where Logloss is the cross entropy of the prediction, and NPR and PPR are negative and positive predictive rates of logistic regression, i.e., precision for negatives and positives population. N_hit and P_hit express accuracy in the negatives and positives population. P_hit is also known as recall, and N_hit as fallout. Neg perc. is the percentage of the negative population to the overall. Negatives are violated tickets, and positives are tickets that have met or achieved the SLA.

Predictive powers of five different machine learning models are compared with respect to both accuracy and cross entropy. These five different machine learning models are support vector machines, logistic regression, Gaussian naïve bayes, k-nearest neighbor, and random forest. Results for accuracy are given in Table 10.

TABLE 10
Machine Learning Model Accuracy Evaluation

| | length | svm | logit | Naïve | knn | forest |
|---|---|---|---|---|---|---|
| Service | 1078 | 0.5600 | 0.5600 | 0.8569 | 0.8569 | 0.7727 |
| Line 1 | | | | | | |
| Service | 3293 | 0.6605 | 0.6605 | 0.4191 | 0.5145 | 0.3554 |
| Line 2 | | | | | | |
| Service | 618 | 0.6359 | 0.6359 | 0.7133 | 0.7058 | 0.6356 |
| Line 3 | | | | | | |
| Service | 167 | 0.4492 | 0.4492 | 0.5141 | 0.6766 | 0.5332 |
| Line 4 | | | | | | |
| Service | 235 | 0.7277 | 0.7277 | 0.7209 | 0.6596 | 0.7112 |
| Line 5 | | | | | | |
| Service | 61 | 0.4923 | 0.4923 | 0.5744 | 0.5410 | 0.5936 |
| Line 6 | | | | | | |
| Service | 27 | 0.8133 | 0.8133 | 0.6200 | 0.7800 | 0.8133 |
| Line 7 | | | | | | |
| Service | 296 | 0.7870 | 0.7870 | 0.8637 | 0.7397 | 0.7028 |
| Line 8 | | | | | | |
| Service | 265 | 0.8227 | 0.8227 | 0.5210 | 0.8152 | 0.7197 |
| Line 9 | | | | | | |
| Service | 188 | 0.9351 | 0.9351 | 0.9568 | 0.9468 | 0.9468 |
| Line 11 | | | | | | |
| Overall | 6228 | 0.6577 | 0.6577 | 0.5821 | 0.6723 | 0.5278 |

Results for cross entropy are given in Table 11.

TABLE 11
Machine Learning Model Cross Entropy Evaluation

| | length | svm | logit | naïve | knn | forest |
|---|---|---|---|---|---|---|
| Service | 1078 | −0.5044 | −0.5044 | −3.3354 | −0.4643 | −0.5736 |
| Line 1 | | | | | | |
| Service | 3293 | −0.7497 | −0.7497 | −2.0914 | −0.7768 | −8.8490 |
| Line 2 | | | | | | |
| Service | 618 | −0.7095 | −0.7095 | −5.8894 | −1.5243 | −0.9291 |
| Line 3 | | | | | | |
| Service | 167 | −0.7077 | −0.7077 | −7.0649 | −0.7455 | −0.9562 |
| Line 4 | | | | | | |
| Service | 235 | −0.6135 | −0.6135 | −2.9357 | −2.1785 | −0.7421 |
| Line 5 | | | | | | |
| Service | 61 | −0.6870 | −0.6870 | −3.2500 | −4.0078 | −0.6437 |
| Line 6 | | | | | | |
| Service | 27 | −0.4958 | −0.4958 | −3.3399 | −1.4969 | −0.4798 |
| Line 7 | | | | | | |
| Service | 296 | −0.3199 | −0.3199 | −3.7272 | −0.7851 | −0.4608 |
| Line 8 | | | | | | |
| Service | 265 | −0.4936 | −0.4936 | −2.5860 | −1.1503 | −0.6360 |
| Line 9 | | | | | | |
| Service | 188 | −0.1316 | −0.1316 | −1.4936 | −0.1250 | −0.0878 |
| Line 11 | | | | | | |
| Overall | 6228 | −0.6453 | −0.6453 | −2.9463 | −0.8803 | −4.9840 |

As illustrated in Tables 9 and 10, logistic regression performs well with respect to both accuracy and cross entropy.

A CASP model can be run for different purposes or focuses depending on the user. Different users of CASP include account DPE's, offerings managers, global service owners and GEO leaders. The specification of the inputs for a given user varies. The inputs and outputs for an Account DPE, Offerings Manager, global service owner and GEO Leaders is given in Tables 12-15.

TABLE 12
Inputs and Outputs for Account DPE

| Input | Specification |
|---|---|
| Target | Profitability |
| Workload | By Tower/Serviceline/time series |
| Risks definition | SLA/CSAT/NPS |
| Optimizer target parameters | Resources by Band/Role/GEO/Cost |
| Constraints | Min/Max change, selection, etc. |
| Output | Results |
| Optimizer recommendation | Staffing By Tower/Serviceline/resources |
| | classification |
| Minimized risk | By Tower/Serviceline/Staffing |

TABLE 13
Inputs and Outputs for Offerings Manager

| Input | Specification |
|---|---|
| Target | Profitability |
| Workload | Services |
| Risks definition | SLA/CSAT |
| Optimizer target parameters | Cost of services |
| Constraints | Min/Max change, service selection, etc. |
| Output | Results |
| Optimizer recommendation | Services |
| Minimized risk | By Tower/Serviceline |

TABLE 14
Inputs and Outputs for Global Service Owners (GSO)

| Input | Specification |
|---|---|
| Target | Profitability |
| Workload | By Accounts/time series |
| Risks definition | SLA/CSAT/NPS |
| Optimizer target parameters | Resources by Band/Role/GEO/Cost |
| Constraints | Min/Max change, selection, etc. |
| Output | Results |
| Optimizer recommendation | Staffing Accounts/resources classification |
| Minimized risk | By Accounts/Staffing |

TABLE 15
Inputs and Outputs for GEO Leaders

| Input | Specification |
|---|---|
| Target | Profitability |
| Workload | By Accounts/servicelines/time series |
| Risks definition | SLA/CSAT/NPS |
| Optimizer target parameters | Resources by Band/Role/GEO/Cost |
| Constraints | Min/Max change, selection, etc. |
| Output | Results |
| Optimizer recommendation | Staffing Accounts/resources classification |
| Minimized risk | By Accounts/Staffing |

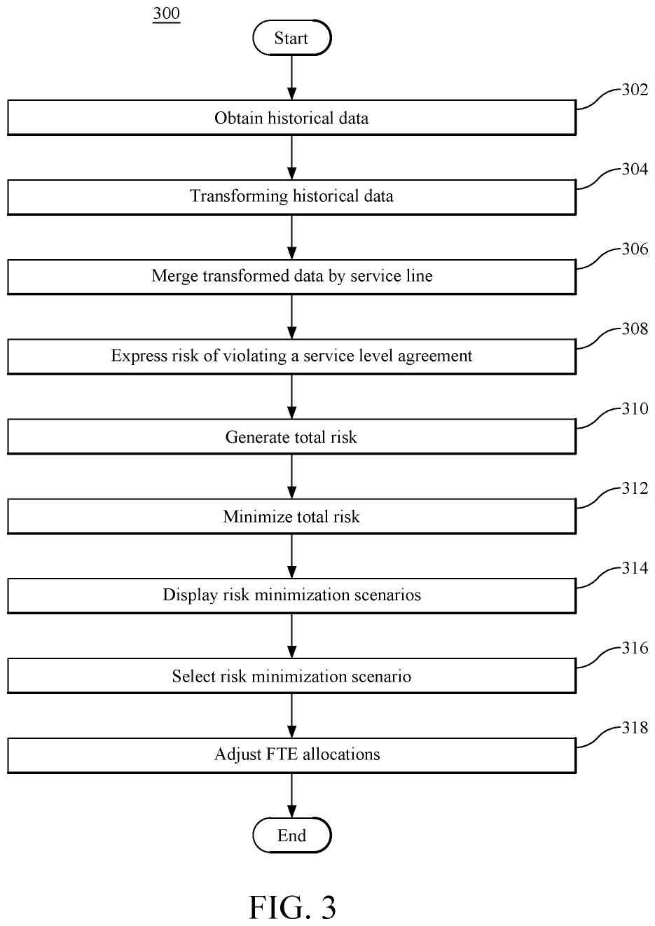

Referring now to FIG. 3, exemplary embodiments are also directed to a method for allocating staffing 300. Historical data for the processing of tickets in the plurality of service lines are obtained 302. The historical data include workload data containing all service tickets received per a given duration of time, e.g., a year, clocking data containing full time equivalent effort used to process all service tickets, service level agreements, and allocated numbers of full time equivalents per service line. The historical data are then transformed 304. Transforming the historical data includes using service ticket mapping files to map each service ticket to a given service line and using clocking data mapping files to map full time equivalent effort to a given service line. Transforming the historical data also includes classifying each service ticket in each service line as a low severity ticket, a medium severity ticket or a high severity ticket and using the service ticket classification to create a low risk class, a medium risk class and a high risk class. In addition, each full time equivalent in the allocated number of full time equivalents in each service line is classified into one of six FTE classification bands. These classification bands are an offshore low classification band, an offshore medium classification band, an offshore high classification band, an onshore low classification band, an onshore medium classification band or an onshore high classification band. Each classification band has a given level of technical competency associated with a given full time equivalent and a cost per unit time associated with each full time equivalent in the classification band. Having transformed and classified the historical data, all transformed historical data are merged by service line 306.

A risk of violating a service level agreement is expressed for a given service line 308. In one embodiment, risk of violating the service level agreement is expressed using the historical data, preferably, the merged transformed historical data. The risk of violating the service level agreement is expressed as a function of a number of full time equivalents allocated to the given service line and a number of service tickets received at the given service line per unit of time per ticket severity level. The number of service tickets are processed by the number of full time equivalents allocated to the given service line. The risk of violating the service level agreement is summed across a plurality of distinct service lines to generate a total risk 310.

In one embodiment, total risk utilizes a count model, and the risk of violating the service level agreement is expressed as an exponential function indicating a number of service level agreement violations for a given service ticket. In another embodiment, total risk utilizes a logistic model, and the risk of violating the service level agreement is expressed as a sigmoidal function indicating a probability of a service level agreement violation for one or more service tickets multiplied by a ticket volume for each service ticket.

Total risk is minimized 312 by adjusting the number of full time equivalents allocated to each given service line across all services lines. Minimization is performed subject to a pre-determined reduction in total cost to process all service tickets by the number of full time equivalents across all service lines and a pre-determined range of a permissible number of full time equivalents for each service line. The result of minimization of total risk is a total cost, a change in the risk of violating a service level agreement for each ticket severity level per service line for all service lines and a change in the number of full time equivalents in each full time equivalent classification band per service line for all service lines that can be displayed to a requesting user.

In one embodiment, minimizing the total risk includes creating at least one and preferably creating a plurality of risk minimization scenarios. Each risk minimization scenario comprises a unique arrangement of changes in the risk of violating the service level agreement for each ticket severity level per service line, changes in the number of full time equivalents in each full time equivalent classification band per service line, and total cost. The plurality of risk minimization scenarios is displayed to the user 314, and the user selects a desired risk minimization scenario 316. The number of full time equivalents in each full time equivalent classification band per service lines across all service lines is adjusted 318, e.g., for a given account, in accordance with the selected one of the risk minimization scenarios. Therefore, FTE allocation is adjusted to achieve the desired balance between total cost and risk minimization one or more accounts.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although a detailed description on cloud computing is provided, implementation of the teachings provided herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service.

This cloud model may include at least five characteristics, at least three service models, and at least four deployment models. The five characteristics are on-demand self-service, broad network access, resource pooling, rapid elasticity and measured service. Regarding on-demand self-service, a cloud consumer can unilaterally provision computing capabilities, such as server time and network storage, as needed automatically without requiring human interaction with the service's provider. Broad network access refers to capabilities that are available over a network and accessed through standard mechanisms that promote use by heterogeneous thin or thick client platforms, e.g., mobile phones, laptops, and PDAs. For resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction, e.g., country, state, or datacenter. Rapid elasticity refers to capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. For measured service, cloud systems automatically control and optimize resource use by leveraging a metering capability at some level of abstraction appropriate to the type of service, e.g., storage, processing, bandwidth, and active user accounts. Resource usage can be monitored, controlled, and reported, providing transparency for both the provider and consumer of the utilized service.

The three service models are Software as a Service (SaaS), Platform as a Service (PaaS) and Infrastructure as a Service (IaaS). Software as a service provides the capability to the consumer to use the provider's applications running on a cloud infrastructure. The applications are accessible from various client devices through a thin client interface such as a web browser, e.g., web-based e-mail. The consumer does not manage or control the underlying cloud infrastructure including network, servers, operating systems, storage, or even individual application capabilities, apart from limited user-specific application configuration settings. Platform as a service provides the capability to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service provides the capability to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components, e.g., host firewalls.

The Deployment Models are private cloud, community cloud, public cloud and hybrid cloud. The private cloud infrastructure is operated solely for an organization. It may be managed by the organization or a third party and may exist on-premises or off-premises. The community cloud infrastructure is shared by several organizations and supports a specific community that has shared concerns, e.g., mission, security requirements, policy, and compliance considerations. It may be managed by the organizations or a third party and may exist on-premises or off-premises. The public cloud infrastructure is made available to the general public or a large industry group and is owned by an organization selling cloud services. The hybrid cloud infrastructure is a composition of two or more clouds (private, community, or public) that remain unique entities but are bound together by standardized or proprietary technology that enables data and application portability, e.g., cloud bursting for load-balancing between clouds.

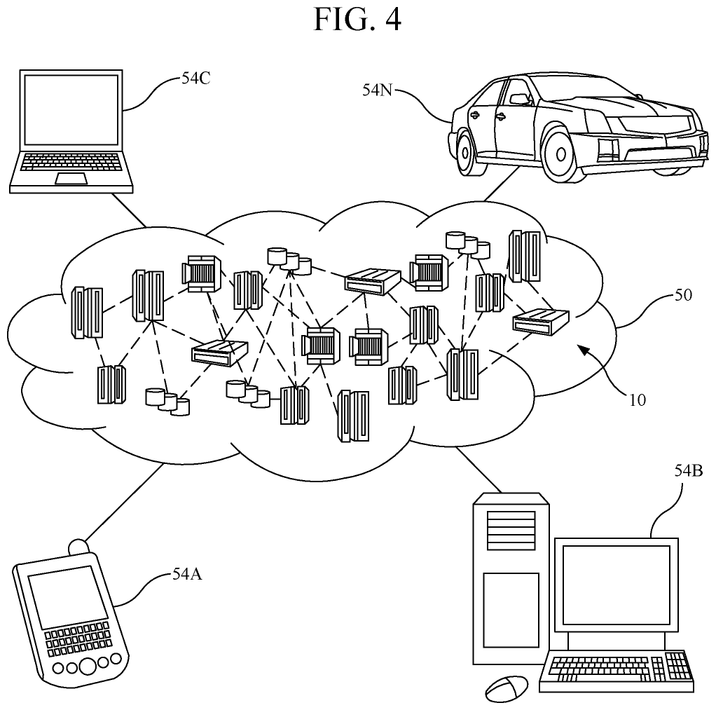

A cloud computing environment is service oriented with a focus on statelessness, low coupling, modularity, and semantic interoperability. At the heart of cloud computing is an infrastructure that includes a network of interconnected nodes. Referring now to FIG. 4, an illustrative cloud computing environment 50 is depicted. As shown, the cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection, e.g., using a web browser.

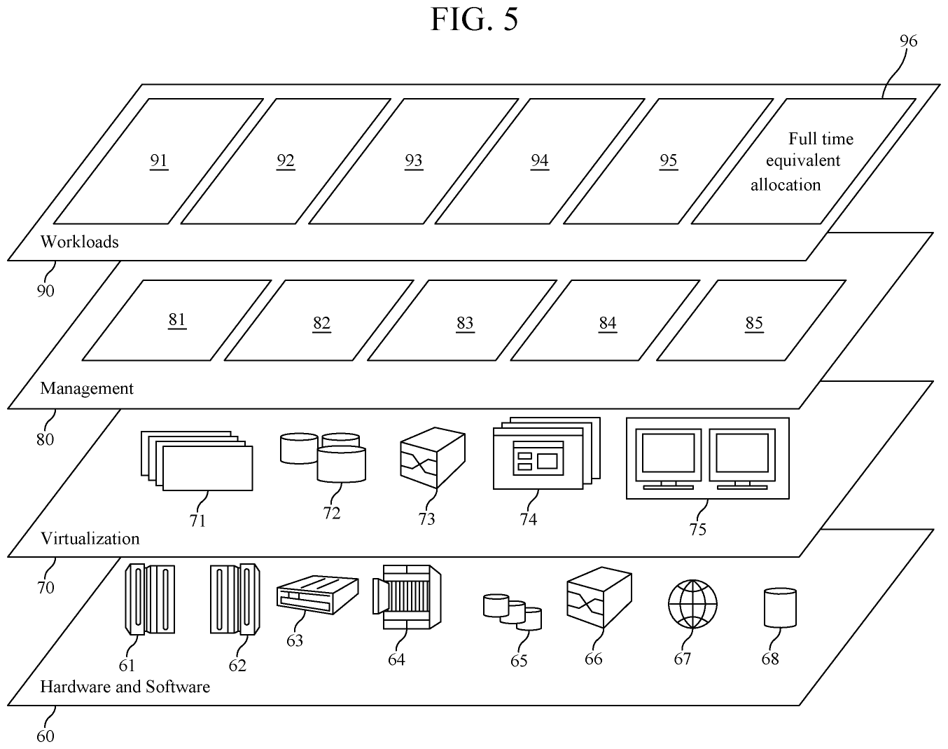

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided. A hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. A virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and full time equivalent allocation 96.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for allocating staffing, the method comprising:
expressing a risk of violating a service level agreement for a given service line as a function of a number of full time equivalents allocated to the given service line and a number of service tickets received at the given service line per unit of time per ticket severity level, the number of service tickets are processed by the number of full time equivalents allocated to the given service line;
summing the risk of violating the service level agreement across a plurality of distinct service lines to generate a total risk; and
minimizing the total risk by adjusting the number of full time equivalents allocated to each given service line across all services lines subject to a pre-determined reduction in total cost to process all service tickets by the number of full time equivalents across all service lines and a pre-determined range of a permissible number of full time equivalents for each service line.

2. The method of claim 1, wherein the method further comprises:
obtaining historical data for the processing of tickets in the plurality of service lines, the historical data comprising workload data comprising all service tickets received per a given duration of time, clocking data comprising full time equivalent effort used to process all service tickets, service level agreements, and allocated numbers of full time equivalents per service line; and
transforming the historical data by:
using service ticket mapping files to map each service ticket to a given service line; and
using clocking data mapping files to map full time equivalent effort to a given service line.

3. The method of claim 2, wherein transforming the historical data further comprises:
classifying each service ticket in each service line as a low severity ticket, a medium severity ticket or a high severity ticket;
using the service ticket classification to create a low risk class, a medium risk class and a high risk class; and
classifying each full time equivalent in the allocated number of full time equivalents in each service line into an offshore low classification band, an offshore medium classification band, an offshore high classification band, an onshore low classification band, an onshore medium classification band or an onshore high classification band, each classification band comprising a given level of technical competency associated with a given full time equivalent and a cost per unit time associated with each full time equivalent in the classification band.

4. The method of claim 3, wherein the method further comprises merging all transformed historical data by service line.

5. The method of claim 4, wherein expressing the risk of violating the service level agreement further comprises using the merged transformed historical data to express the risk of violating the service level agreement.

6. The method of claim 1, wherein:
total risk comprises a count model; and
expressing the risk of violating the service level agreement further comprises expressing the risk of violating the service level agreement as an exponential function indicating a number of service level agreement violations for a given service ticket.

7. The method of claim 1, wherein:
total risk comprises a logistic model; and
expressing the risk of violating the service level agreement further comprises expressing the risk of violating the service level agreement as a sigmoidal function indicating a probability of a service level agreement violation for one or more service tickets multiplied by a ticket volume for each service ticket.

8. The method of claim 1, wherein the method further comprises displaying a total cost, a change in the risk of violating a service level agreement for each ticket severity level per service line for all service lines and a change in the number of full time equivalents in each full time equivalent classification band per service line for all service lines as a result of minimizing total risk.

9. The method of claim 1, wherein:
minimizing the total risk comprises creating a risk minimization scenario comprising a given change in the risk of violating a service level agreement for each ticket severity level per service line, a given change in the number of full time equivalents in each full time equivalent classification band per service line, and a total cost; and
the method further comprises:
creating a plurality of risk minimization scenarios, each risk minimization scenario comprising a unique arrangement of changes in the risk of violating the service level agreement for each ticket severity level per service line, changes in the number of full time equivalents in each full time equivalent classification band per service line, and total cost;
displaying the plurality of risk minimization scenarios; and
adjusting the number of full time equivalents in each full time equivalent classification band per service lines across all service lines in accordance with one of the risk minimization scenarios.

10. A computer-readable medium containing a computer-readable code that when read by a computer causes the computer to perform method for allocating staffing, the method comprising:
expressing a risk of violating a service level agreement for a given service line as a function of a number of full time equivalents allocated to the given service line and a number of service tickets received at the given service line per unit of time per ticket severity level, the number of service tickets are processed by the number of full time equivalents allocated to the given service line;
summing the risk of violating the service level agreement across a plurality of distinct service lines to generate a total risk; and
minimizing the total risk by adjusting the number of full time equivalents allocated to each given service line across all services lines subject to a pre-determined reduction in total cost to process all service tickets by the number of full time equivalents across all service lines and a pre-determined range of a permissible number of full time equivalents for each service line.

11. The computer-readable medium of claim 10, wherein the method further comprises:
obtaining historical data for the processing of tickets in the plurality of service lines, the historical data comprising workload data comprising all service tickets received per a given duration of time, clocking data comprising full time equivalent effort used to process all service tickets, service level agreements, and allocated numbers of full time equivalents per service line; and
transforming the historical data by:
using service ticket mapping files to map each service ticket to a given service line; and
using clocking data mapping files to map full time equivalent effort to a given service line.

12. The computer-readable medium of claim 11, wherein transforming the historical data further comprises:
classifying each service ticket in each service line as a low severity ticket, a medium severity ticket or a high severity ticket;
using the service ticket classification to create a low risk class, a medium risk class and a high risk class; and
classifying each full time equivalent in the allocated number of full time equivalents in each service line into an offshore low classification band, an offshore medium classification band, an offshore high classification band, an onshore low classification band, an onshore medium classification band or an onshore high classification band, each classification band comprising a given level of technical competency associated with a given full time equivalent and a cost per unit time associated with each full time equivalent in the classification band.

13. The computer-readable medium of claim 12, wherein the method further comprises merging all transformed historical data by service line.

14. The computer-readable medium of claim 13, wherein expressing the risk of violating the service level agreement further comprises using the merged transformed historical data to express the risk of violating the service level agreement.

15. The computer-readable medium of claim 10, wherein:
total risk comprises a count model; and
expressing the risk of violating the service level agreement further comprises expressing the risk of violating the service level agreement as an exponential function indicating a number of service level agreement violations for a given service ticket.

16. The computer-readable medium of claim 10, wherein:
total risk comprises a logistic model; and
expressing the risk of violating the service level agreement further comprises expressing the risk of violating the service level agreement as a sigmoidal function indicating a probability of a service level agreement violation for one or more service tickets multiplied by a ticket volume for each service ticket.

17. The computer-readable medium of claim 10, wherein the method further comprises displaying a total cost, a change in the risk of violating a service level agreement for each ticket severity level per service line for all service lines and a change in the number of full time equivalents in each full time equivalent classification band per service line for all service lines as a result of minimizing total risk.

18. The computer-readable medium of claim 10, wherein:
minimizing the total risk comprises creating a risk minimization scenario comprising a given change in the risk of violating a service level agreement for each ticket severity level per service line, a given change in the number of full time equivalents in each full time equivalent classification band per service line, and a total cost; and
the method further comprises:
creating a plurality of risk minimization scenarios, each risk minimization scenario comprising a unique arrangement of changes in the risk of violating the service level agreement for each ticket severity level per service line, changes in the number of full time equivalents in each full time equivalent classification band per service line, and total cost;
displaying the plurality of risk minimization scenarios; and
adjusting the number of full time equivalents in each full time equivalent classification band per service lines across all service lines in accordance with one of the risk minimization scenarios.

19. A system for allocating staffing, the system comprising:
a database containing historical data for the processing of service tickets in a plurality of service lines, the historical data comprising workload data comprising all service tickets received per a given duration of time, clocking data comprising full time equivalent effort used to process all service tickets, service level agreements, and allocated numbers of full time equivalents per service line;
a risk modeler and optimizer module to use the historical data to express a risk of violating a service level agreement for a given service line as a function of a number of full time equivalents assigned to the given service line and a number of service tickets received at the given service line per unit of time per ticket severity level, the number of service tickets are processed by the number of full time equivalents allocated to the given service line, to generate a total risk by summing the risk of violating the service level agreement across a plurality of distinct service lines, and to minimize the total risk by adjusting the number of full time equivalents allocated to each given service line across all services lines to create a plurality of risk minimization scenarios, each risk minimization scenario comprising a unique arrangement of changes in the risk of violating the service level agreement for each ticket severity level per service line, changes in the number of full time equivalents in each full time equivalent classification band per service line, and total cost; and
a user interface and scenario output module in communication with the risk modeler and optimizer module to display the plurality of risk minimization scenarios.

20. The system of claim 19, wherein the system further comprises:
a data transformer module in communication with the dataset and the risk modeler and optimizer module to transform the historical data by using service ticket mapping files to map each service ticket to a given service line, to use clocking data mapping files to map full time equivalent effort to a given service line, to classify each service ticket in each service line as a low severity ticket, a medium severity ticket or a high severity ticket, to use the service ticket classification to create a low risk class, a medium risk class and a high risk class, to classify each full time equivalent in the allocated number of full time equivalents in each service line into an offshore low classification band, an offshore medium classification band, an offshore high classification band, an onshore low classification band, an onshore medium classification band or an onshore high classification band, each classification band comprising a given level of technical competency associated with a given full time equivalent and a cost per unit time associated with each full time equivalent in the classification band, and to merge all transformed historical data by service line;
wherein the risk modeler and optimizer module uses the merged transformed historical data to express a risk of violating a service level agreement.
